(19) United States
(12) Patent Application Publication
(10) Pub. No.: US 2022/0058406 A1
(43) Pub. Date: Feb. 24, 2022

(54) MORE FLEXIBLE ITERATIVE OPERATION OF ARTIFICIAL NEURAL NETWORKS

(71) Applicant: Robert Bosch GmbH, Stuttgart (DE)

(72) Inventor: Thomas Pfeil, Renningen (DE)

(21) Appl. No.: 17/394,780

(22) Filed: Aug. 5, 2021

(30) Foreign Application Priority Data
Aug. 24, 2020 (DE) 102020210700.9

(51) Int. Cl. G06K 9/00; G06K 9/62; G06N 3/04

(52) U.S. Cl. CPC G06K 9/00845; G06K 9/6256; G06N 3/04; G06K 9/6267

(57) ABSTRACT

A method which processes inputs in a sequence of layers to form outputs. Within an artificial neural network (ANN), at least one iterative block including one or more layer(s) is established, which is to be implemented multiple times. A number J of iterations is established, for which this iterative block is at most to be implemented. An input of the iterative block is mapped by the iterative block onto an output. This output is again fed to the iterative block as input and again mapped by the iterative block onto a new output. Once the iterative block has been implemented J-times, the output supplied by the iterative block is fed as the input to a following layer or is provided as output of the ANN. A portion of the parameters, which characterize the behavior of the layers in the iterative block, is changed during the switch between the iterations.

### CROSS REFERENCE

The present application claims the benefit under 35 U.S.C. § 119 of German Patent Application No. DE 102020210700.9 filed on Aug. 24, 2020, which is expressly incorporated herein by reference in its entirety.

### FIELD

The present invention relates to the operation of artificial neural networks, in particular, under the constraint of limited hardware and energy resources on board vehicles.

### BACKGROUND INFORMATION

The driving of a vehicle in road traffic by a human driver is generally trained by confronting a student driver repeatedly with a particular canon of situations in conjunction with his/her training. The student driver must react to each of these situations and receives feedback via commentary or even an intervention of the driving instructor as to whether his/her reaction was correct or incorrect. This training including a finite number of situations is intended to enable the student driver to also master unknown situations when driving the vehicle on his/her own.

To allow vehicles to drive in road traffic in a fully or partially automated manner, the aim is to control these vehicles using neural networks trainable in a very similar manner. These networks receive, for example, sensor data from the vehicle surroundings as inputs and supply activation signals as outputs, which are used to intervene in the operation of the vehicle, and/or as pre-products, from which such activation signals are formed. For example, a classification of objects in the surroundings of the vehicle, and/or a semantic segmentation of the surroundings of the vehicle may be such a pre-product.

### SUMMARY

A method is provided within the scope of the present invention for operating an artificial neural network, ANN. The ANN processes inputs in a sequence of layers to form outputs. These layers may include convolution layers, pooling layers or fully interconnected layers.

The inputs of the ANN may include, for example, measured data, which have been recorded using one or multiple sensors. The outputs of the ANN may include, for example, one or multiple classification scores, with which the assignment of the measured data to one or to multiple class(es) of a predefined classification is expressed.

In accordance with an example embodiment of the present invention, at least one iterative block made up of one or of multiple layers is established within the ANN. During the processing of a specific set of inputs to form a specific set of outputs, this iterative block is to be implemented multiple times.

For this purpose, a number J of iterations is established, for which the iterative block is at most to be implemented. An input of the iterative block is then mapped by the iterative block onto an output. This output is again fed to the iterative block as input and once again mapped by the iterative block onto a new output. Once the iterations of the iterative block are completed, the output supplied by the iterative block is fed as input to the layer of the ANN following the iterative block. If, however, the iterative block is no longer followed by any layer of the ANN, this output is provided as output of the ANN.

The number J of the iterations at most to be carried out may be established, for example, based on the available hardware resources and/or computing time. The iteration may, however, be terminated prematurely if a predefined abort criterion is met. For example, the iteration may be terminated if the output of the iterative block is sufficiently well converged against an end result.

By implementing the iterative block multiple times, the hardware on which the iterative block is implemented is passed through multiple times during the processing of a specific input of the ANN to form a specific output of the ANN. A predefined processing task may therefore be carried out using fewer hardware resources than if the hardware were to be passed through by the data only one single time in one direction. The hardware may therefore be designed smaller on the whole, which is advantageous, in particular, in control units for vehicles.

One or multiple parameters, which characterize the behavior of the layers in the iterative block, are changed during the switch between the iterations for which the iterative block is implemented.

It has been found that when implementing an iterative block in an ANN, there may be a conflict of objectives depending on the hardware platform used between the quality of the output ultimately obtained by the ANN on the one hand and the power requirement on the other hand. When iteratively implementing an iterative block, the parameters that characterize the behavior of the layers in the iterative block are usually retained during all iterations. The reason therefore is that many hardware platforms, which enable the highly efficient implementation of an iterative block, in return “penalize” changes of the aforementioned parameters with an increased power requirement and/or with losses of speed. Thus, for example, a high efficiency of the hardware platform with a simultaneously small overall size may involve the fact that less bandwidth is available for changes in the parameters. On such hardware platforms, in particular, it is also possible to use memory elements, which may be very quickly read, but in return are significantly slower to write and require a disproportionate amount of power for writing.

If therefore the hardware platforms were to always be completely newly fitted between two iterations with parameters for the next iteration, the combination of iterative implementation and the specific hardware platform would be comparatively slow and would consume more power. On the other hand, the re-use of the parameters for all iterations robs the ANN of a high degree of flexibility. The ANN must be larger on the whole, so that its behavior on the whole is characterized by significantly more parameters. At the same time, ANNs that are used as classifiers, for example, achieve on the whole a poorer classification accuracy in the final state of their training if the parameters of the iterative block are retained for all iterations.

Therefore, in accordance with an example embodiment of the present invention, a portion of the parameters that characterize the behavior of the layers in the iterative block is changed during the switch between the iterations for which the iterative block is implemented. Neither are all parameters changed, nor are all parameters retained.

It has been found, that starting from the state in which all parameters are retained, the change of a few parameters yields a gain in flexibility, which significantly reduces the necessary size of the ANN and, at the same time, improves the classification accuracy in the case of classifiers, for example. In contrast, an increased demand for power and/or time for changing these few parameters between the iterations is not yet a factor. In a first approximation, the gain in flexibility, i.e., per additionally changed parameter, effectuates a certain quantum of advantageous effect, which is particularly large for the first changed parameters, and then drops relatively quickly until a state of saturation is reached. The price in power and/or speed to be paid per additionally changed parameter on the other hand is in a first approximation constant. A “break-even” is therefore reached at a particular number of changed parameters, beyond which the change of even more parameters is rather a disadvantage than an advantage.

In one particularly advantageous embodiment, therefore, starting from at least one iteration, a proportion of between 1% and 20%, preferably between 1% and 15%, of the parameters that characterize the behavior of the layers in the iterative block, are changed during the switch to the next iteration.

In one further particularly advantageous embodiment, a portion of the parameters is changed with a first switch between iterations and a second portion of parameters is changed with a second switch between iterations. In this case, the second portion is not congruent with the first portion. The two portions may, however, include the same number of parameters. In this way, it is possible for the iteratively implemented block to gain even greater flexibility without this having to be acquired with an even greater expenditure of time or energy.

In one further advantageous embodiment of the present invention, the parameters that characterize the behavior of the iterative block are stored in a memory, in which each write operation physically acts upon the memory locations of multiple parameters. Starting with at least one iteration, all parameters whose memory locations are physically acted upon by at least one write operation are changed during the switch to the next iteration.

For example, the memory may be designed in such a way that each write operation always acts upon an entire row or column in an array, and/or upon a cohesive block in the memory. If the expenditure of time and/or energy for writing the rows, the columns, the blocks or the area otherwise acted upon by the write operation must already be considered in order to change one or multiple of the parameters in this area, then this expenditure does not increase further if all parameters in this area are changed. Instead, further flexibility may be gained “free of charge” as a result.

In one particularly advantageous embodiment of the present invention, the parameters are coded in electrical resistance values of memristors or of other memory elements, whose electrical resistance values are changeable in a non-volatile manner using a programming voltage or a programming current. These are memory elements that may be read out very quickly by determining the electrical resistance value, but by comparison thereto are writable slowly and with increased power expenditure in return. The memory density in bits per area or per volume is significantly greater than, for example, in the case of DRAM memories on a semiconductor base. Such memory elements may further have a limited service life in terms of write cycles, so that the change of merely one portion of the parameters increases the service life of the memory element.

In one further particularly advantageous embodiment of the present invention, an ANN is selected, which processes inputs initially including multiple convolution layers and ascertains from the result obtained therefrom with at least one further layer at least one classification score relating to a predefined classification. The iterative block is then established in such a way that it includes at least a portion of the convolution layers. A particularly large amount of hardware may be saved thereby as compared to the implementation of an ANN, which is passed through merely once and in only one direction. In this case, it is particularly advantageous if the first convolution layer, to which the inputs of the ANN are fed, is not yet part of the iterative block. This convolution layer then still has the maximum flexibility in order to meaningfully reduce the dimensionality of the input. The number of arithmetic operations required for such purpose is then still not yet increased by the iterative implementation. In the further, iteratively implemented convolution layers, successive features may be subsequently extracted from the inputs before the classification score is then ascertained from these features, for example, with a fully interconnected layer.

The inputs may, in particular, be image data and/or time series data, for example. These data types in particular are particularly high-dimensional, so that the processing using iteratively implemented convolution layers is particularly advantageous.

In one further particularly advantageous embodiment of the present invention, the mapping of an input of the iterative block onto an output of this block includes adding up with the aid of analog electronics inputs in a weighted manner, which are fed to neurons and/or to other processing units in the iterative block. The major portion of the effort for calculating the output of the iterative block lies in these weighted summations, also referred to as “Multiply-and-Accumulate” (MAC). With the aid of analog electronics, it is possible to carry out these calculations in a particularly rapid and energy-efficient manner. In this context, the aforementioned memories based on electrical resistance values are also advantageous. Further calculations may be directly made using the electrical resistance values without having to initially convert them to digital and then back to analog.

An existing, fully trained ANN may be implemented without new training “list-and-shift” in such a way that it may be operated using the method described herein. The ANN delivers even better results if already during training it is able to be attuned to the fact that it will be operated using this method. The present invention therefore also relates to a method for training an ANN for the operation according to the above-described method.

In this method, learning inputs as well as associated learning outputs onto which the ANN is to map in each case the learning inputs are provided. The deviation of the outputs from the learning outputs is assessed using a predefined loss function.

The parameters that characterize the behavior of the layers in the iterative block, including their changes during the switch between the iterations, are optimized to the extent that during further processing of learning inputs by the ANN, the assessment is likely improved with the aid of the loss function.

In this way, it is possible to utilize, in particular, a predefined number of parameters, for example, which are to be changed during the switch between the iterations, in such a way that, a preferably good performance of the ANN with respect to the trained task is achieved as a result of the flexibility gained thereby.

One additional object of the optimization may, however, also be which and/or how many parameters, that characterize the behavior of the layers in the iterative block, are even to be changed during the switch between iterations. For this purpose, the loss function may contain a contribution, for example, which is a function of the number of the parameters changed when switching between iterations, of the rate of change of these changed parameters, and/or of the absolute or relative change across all parameters. In this way, it is possible, for example, to weigh the advantage, produced by the gain in flexibility as a result of the additional changing of a parameter, against the power and time expenditure for this change.

This contribution may, for example, have the form

$$L = {\sum }_{j}^{J - 1} {\sum }_{i}^{I} ‖ {w}_{i}^{j} , {w}_{i}^{j + 1} ‖$$

Here, wᵢ^{j} are the parameters that characterize the behavior of the layers in the iterative block. Subscript i denotes the individual parameters, superscript j denotes the iterations. I denotes the total number of the parameters present and J denotes the total number of iterations. Thus, L measures the absolute or relative change across all parameters according to an arbitrary norm, for example, an L₀ norm, an L₁ norm, an L₂ norm or an L_{∞□} norm. An L₀ norm measures the number of the parameters that change.

In one further advantageous embodiment of the present invention, it is possible, simultaneously and/or in the switch with the parameters that characterize the behavior of the layers in the iterative block, to also optimize with the aid of the loss function further parameters that characterize the behavior of further neurons and/or of other processing units of the ANN outside the iterative block for a likely better assessment. The non-iteratively implemented portions of the ANN may then at least partially compensate for losses in the accuracy that come with the sacrifice in flexibility brought about in the iterative block of the ANN.

As explained above, the iterative implementation of portions of an ANN, in particular, on board vehicles, is advantageous, where both additional space for hardware as well as power from the vehicle electrical system are limited resources.

The present invention therefore also relates to a control unit for a vehicle. In accordance with an example embodiment of the present invention, this control unit includes an input interface, which is connectable to one or to multiple sensor(s) of the vehicle, as well as an output interface, which is connectable to one or to multiple actuator(s) of the vehicle. The control unit further includes an ANN. This ANN is involved in the processing of measured data obtained via the input interface from the sensor or sensors to form an activation signal for the output interface. This ANN is further configured for carrying out the method described at the outset. In this setting, the above-discussed saving of both hardware resources as well as power is particularly advantageous.

The methods may, in particular, be wholly or partially computer-implemented. The present invention therefore also relates to a computer program including machine-readable instructions which, when they are executed on one or on multiple computer(s), prompt the computer or computers to carry out one of the described methods. In this sense, control units for vehicles and embedded systems for technical devices, which are also able to execute machine-readable instructions, are also to be considered computers.

The present invention also relates to a machine-readable data medium and/or to a download product including the computer program. A download product is a digital product transferrable via a data network, i.e., downloadable by a user of the data network, which may be offered for sale in an online shop for immediate download.

A computer may further be equipped with the computer program, with the machine-readable data medium or with the download product.

### BRIEF DESCRIPTION OF THE DRAWINGS

Further measures improving the present invention are represented in greater detail below together with the description of the preferred exemplary embodiments of the present invention with reference to the figures.

FIG. 1 shows an exemplary embodiment method 100 for operating ANN 1, in accordance with an example embodiment of the present invention.

FIG. 2 shows an exemplary implementation of method 100 on a classifier network, in accordance with the present invention.

FIG. 3 shows an exemplary embodiment of method 200 for training ANN 1, in accordance with the present invention.

FIG. 4 shows an exemplary embodiment of control unit 51 for a vehicle 50, in accordance with the present invention.

FIG. 5 shows an illustration of the advantage of changing merely some parameters of the iterative block, in accordance with an example embodiment of the present invention.

### DETAILED DESCRIPTION OF EXAMPLE EMBODIMENTS

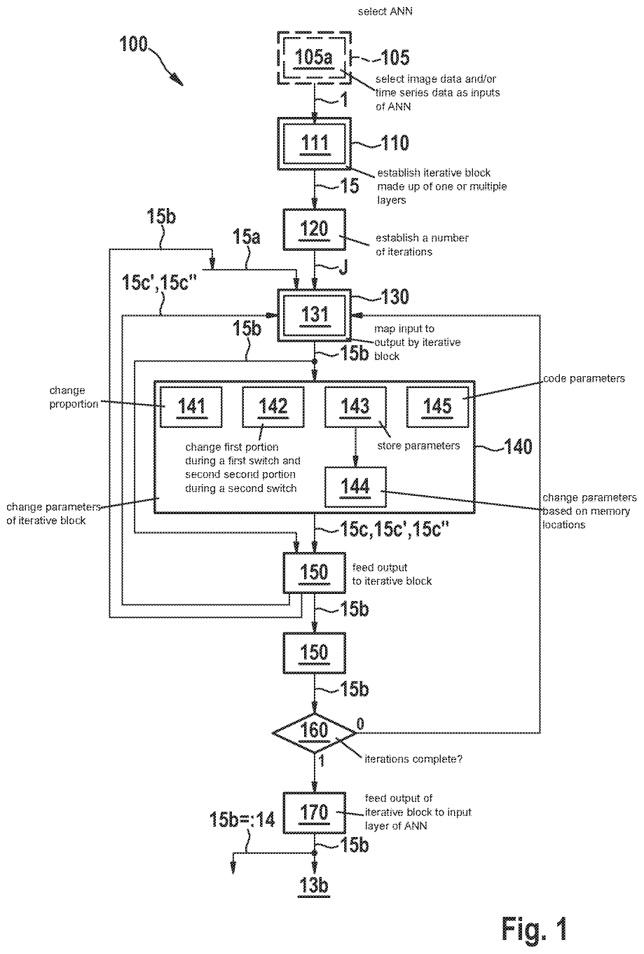

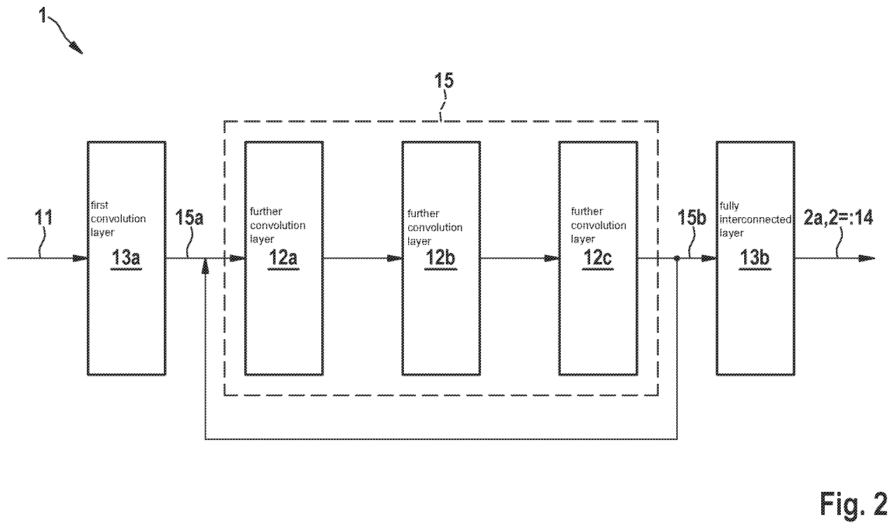

FIG. 1 is a schematic flowchart of one exemplary embodiment of method 100 for operating ANN 1. ANN 1 includes a sequence of layers 12a through 12c, 13a through 13b, with which inputs 11 are processed to form outputs 14. These layers are elucidated in greater detail in FIG. 2.

In step 110, at least one iterative block 15 made up of one or multiple layers 12a through 12c, which is to be implemented multiple times, is established within ANN 1. In step 120, a number J of iterations is established, for which this iterative block 15 is to be implemented.

According to the architecture of ANN 1, iterative block 15 receives a particular input 15a. This input 15a is mapped in step 130 by iterative block 15 onto an output 15b. In this case, the behavior of iterative block 15 is characterized by parameters 15c. These parameters 15c may, for example, be weights, with which inputs, which are fed to a neuron or to another processing unit of ANN 1, are calculated to activate this neuron or this other processing unit.

In step 140, a portion 15c′ of these parameters 15c is changed before iterative block 15 is implemented in the next iteration. Thus, neither do all parameters 15c remain unchanged, nor are all parameters 15c changed.

In order to carry out the next iteration, output 15b generated previously by iterative block 15 is again fed as input 15a to iterative block 15 in step 150.

In step 160, it is checked whether the iterations of iterative block 15 have been completed. The iterations are completed if J iterations have already been run through or if another predefined abort criterion is met, depending on what occurs first. If the iterations are not yet completed (truth value 0), a return to step 140 is made for changing a portion 15c′ of the parameters and to step 150 for a subsequent run-through of a further iteration. If, however, the iterations are completed (truth value 1), output 15b of iterative block 15 is fed in step 170 as input to layer 13b of ANN 1 following iterative block 15. If there is no longer any such following layer 13b, output 15b of iterative block 15 is provided as output 14 of ANN 1.

An ANN 1 may optionally be selected in step 105, which processes inputs 11 initially including multiple convolution layers 13a, 12a through 12c and ascertains from the result obtained hereby including at least one further layer 13b as output 15 at least one classification score 2a relating to a predefined classification 2. According to block 111, iterative block 15 may then be established in such a way that it includes at least a portion 12a through 12c of convolution layers 13a, 12a through 12c. This is represented in greater detail in FIG. 2.

Image data and/or time series data may, in particular, be selected as inputs 11 of ANN 1, for example, according to block 105a.

The mapping of an input 15a of iterative block 15 onto an output 15b may include according to block 131 in particular, for example, adding up with the aid of analog electronics inputs in a weighted manner, which are fed to neurons and/or to other processing units in the iterative block (Multiply and Accumulate, MAC).

According to block 141, a proportion 15c′ of between 1% and 20%, preferably between 1% and 15% of the parameters 15c, for example, which characterize the behavior of layers 12a through 12c in iterative block 15 may, in particular, be changed during the switch to the next iteration.

According to block 142, a first portion 15c′ of parameters 15c may be changed during a first switch between iterations and a second portion 15c′ of parameters 15c may be changed during a second switch between iterations. In this case, second portion 15c″ is not congruent with first portion 15c′.

According to block 143, parameters 15c may be stored in a memory, in which each write operation physically acts upon the memory locations of multiple parameters 15c. According to block 144, starting from at least one iteration, all parameters 15c whose memory locations are physically acted upon by at least one write operation may then be changed during the switch to the next iteration.

According to block 145, parameters 15c may be coded in electrical resistance values of memristors or of other memory elements, whose electrical resistance values are changeable in a non-volatile manner using a programming voltage or a programming current.

FIG. 2 shows an exemplary implementation of the method at a classifier network as ANN 1. ANN 1 receives measured data as inputs 11 and outputs classification scores 2a for these measured data relating to a predefined classification 2 as outputs 14.

For this purpose, the dimensionality of the measured data is reduced in a first convolution layer 13a before successive features in the measured data are identified in further convolution layers 12a through 12c. This further identification of features may take place, for example, simultaneously or successively on various size scales.

The further convolution layers 12a through 12c are combined to form iterative block 15, which receives its input from first convolution layer 13a and is implemented multiple times. In the process, output 15b of one iteration is used in each case as input 15a of the next iteration.

When the iterations of iterative block 15 are completed, output 15b of iterative block 15 is forwarded to fully interconnected layer 13b, where classification scores 2a are formed. Alternatively, a classification score 2a may also be calculated with each iteration.

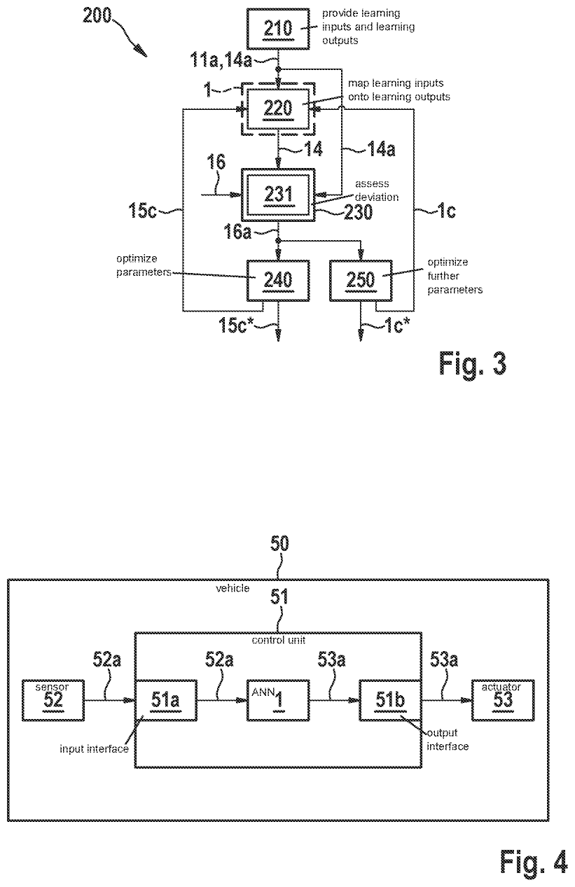

FIG. 3 is a schematic flowchart of one exemplary embodiment of method 200 for training ANN 1.

In step 210, learning inputs 11a as well as associated learning outputs 14a are provided, onto which ANN 1 is to map in each case learning inputs 11a. These learning inputs 11a are mapped in step 220 by ANN 1 onto outputs 14. The deviation of outputs 14 from learning outputs 14a is assessed in step 230 using a predefined loss function 16.

In step 240, parameters 15c, which characterize the behavior of layers 12a through 12c, 13a in iterative block 15, including their changes during the switch between the iterations, are optimized to the extent that during further processing of learning inputs 11a by ANN 1, assessment 16a is likely improved with the aid of loss function 16.

In step 250, further parameters 1c, which characterize the behavior of further neurons and/or of other processing units of ANN 1 outside iterative block 15, are optimized simultaneously or alternatingly thereto with the aid of loss function 16 for a likely better assessment 16a.

The fully trained state of parameters 15c is identified with reference numeral 15c*. The fully trained state of parameters 1c is identified with reference numeral 1c*.

FIG. 4 shows one exemplary embodiment of control unit 51 for a vehicle 50. Control unit 51 includes an input interface 51a, which is connected here to a sensor 52 of vehicle 50 and receives measured data 52a from this sensor 52. Measured data 52a are processed with the assistance of an ANN 1 to form an activation signal 53a, which is intended for an actuator 53 of vehicle 50. Activation signal 53a is forwarded to actuator 53 via an output interface 51b of control unit 51, to which actuator 53 is connected.

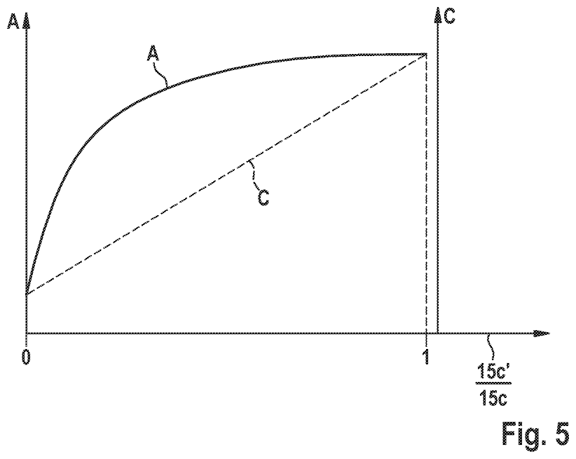

FIG. 5 schematically illustrates the advantage gained during the switch between iterations by changing merely a portion 15c′ of parameters 15c, which characterize the behavior of iterative block 15. Both the classification accuracy A of an ANN 1 used as a classifier network as well as energy costs C for the operation of this ANN 1 are plotted over quotient 15c′/15c of the number of changed parameters 15c′ and the number of the total parameters 15c present.

Certain energy costs C also accrue when no parameters 15c are changed. Starting with this basic amount, energy costs C increase linearly with the number of changed parameters 15c′. Classification accuracy A, however, increases non-linearly. It increases drastically already if only a few parameters 15c′ are changed. This growth weakens with the increasing number of changed parameters 15c′ and at some point reaches a state of saturation. It is therefore advantageous to exploit for a small price of additional energy costs C the initially large increase in classification accuracy A.

What is claimed is:

1. A method for operating an artificial neural network (ANN), which processes inputs in a sequence of layers to form outputs, the method comprising the following steps:
establishing, within the ANN, at least one iterative block, made up of one or of multiple layers, which is to be implemented multiple times;
establishing a number J of iterations, for which the iterative block is at most to be implemented;
mapping, by the iterative block, an input of the iterative block onto an output;
feeding the output to the iterative block as input and again mapping by the iterative block onto a new output; and
feeding, once the iterations of the iterative block are completed, the output supplied by the iterative block input to a layer of the ANN following the iterative block, or providing the output supplied by the iterative block as output of the ANN;
wherein a portion of parameters, which characterize a behavior of the layers in the iterative block, is changed during switches between the iterations, for which the iterative block is implemented.

2. The method as recited in claim 1, wherein, starting from at least one iteration of the iterative block, a proportion of between 1% and 20% of the parameters which characterize the behavior of the layers in the iterative block, are changed during the switch to a next iteration.

3. The method as recited in claim 2, wherein the proportion is between 1% and 15%.

4. The method as recited in claim 1, wherein a first portion of the parameters is changed during a first switch between iterations and a second portion of the parameters is changed during a second switch between iterations, the second portion not being congruent with the first portion.

5. The method as recited in claim 1, wherein the parameters are stored in a memory, in which each write operation physically acts upon memory locations of multiple parameters and, starting from at least one iteration, all parameters, whose memory locations are acted upon by at least one write operation, are changed during the switch to the next iteration.

6. The method as recited in claim 1, wherein the parameters are coded in electrical resistance values of memristors or of other memory elements, whose electrical resistance values are changeable in a non-volatile manner using a programming voltage or a programming current.

7. The method as recited in claim 1, wherein the ANN is selected, which processes inputs initially including multiple convolution layers and ascertains from a result obtained with at least one further layer as output at least one classification score relating to a predefined classification, and the iterative block is established in such a way that the iterative block includes at least a portion of the convolution layers.

8. The method as recited in claim 7, wherein image data and/or time series data are selected as the inputs of the ANN.

9. The method as recited in claim 1, wherein the mapping of the input of the iterative block onto the output includes adding up using analog electronics, inputs in a weighted manner, which are fed to neurons and/or to other processing units in the iterative block.

10. A method for training an artificial neural network (ANN), comprising the following steps:
providing learning inputs and associated learning outputs onto which the ANN is to map in each case the learning inputs;
mapping the learning inputs by the ANN onto outputs;
assessing a deviation of the outputs from the learning outputs, using a predefined loss function; and
optimizing parameters which characterize a behavior of layers in an iterative block of the ANN, including changes of the parameters during switches between the iterations, to the extent that during further processing of learning inputs by the ANN, the assessment is likely improved using the loss function.

11. The method as recited in claim 10, wherein the loss function contains a contribution, which is a function of the number of the parameters changed during the switch between iterations, of a rate of change of the changed parameters and/or of an absolute or relative change across all parameters.

12. The method as recited in claim 10, wherein simultaneously to and/or in alternation with the parameters, which characterize the behavior of the layers in the iterative block, further parameters, which characterize behavior of further neurons and/or of other processing units of the ANN outside the iterative block, are also optimized using the loss function for a likely better assessment.

13. A control unit for a vehicle, comprising:
an input interface, which is connectable to one or to multiple sensors of the vehicle;
an output interface, which is connectable to one or to multiple actuators of the vehicle;
an artificial neural network (ANN) configured to be involved in processing of measured data obtained via the input interface from the one or more sensors to form an activation signal for the output interface, wherein at least one iterative block is established within the ANN made up of one or multiple layers, which is to be implemented multiple times, and a number J of iterations is established for which the iterative block is at most to be implemented;
wherein the iterative block is configured to map an input of the iterative block is mapped by the iterative block onto an output;
wherein the output is fed to the iterative block as input and which again maps onto a new output; and
once the iterations of the iterative block are completed, the output supplied by the iterative block input is fed to a layer of the ANN following the iterative block, or the output supplied by the iterative block is provided by the iterative block as output of the ANN;
wherein a portion of parameters, which characterize a behavior of the layers in the iterative block, is changed during switches between the iterations, for which the iterative block is implemented.

14. A non-transitory machine-readable data medium on which is stored a computer program for operating an artificial neural network (ANN), which processes inputs in a sequence of layers to form outputs, the computer program, when executed by one or more computers, causes the one or more computers to perform the following steps:
establishing, within the ANN, at least one iterative block, made up of one or of multiple layers, which is to be implemented multiple times;
establishing a number J of iterations, for which the iterative block is at most to be implemented;
mapping, by the iterative block, an input of the iterative block onto an output;
feeding the output to the iterative block as input and again mapping by the iterative block onto a new output; and
feeding, once the iterations of the iterative block are completed, the output supplied by the iterative block input to a layer of the ANN following the iterative block, or providing the output supplied by the iterative block as output of the ANN;
wherein a portion of parameters, which characterize a behavior of the layers in the iterative block, is changed during switches between the iterations, for which the iterative block is implemented.

15. A computer configured to operate an artificial neural network (ANN), which processes inputs in a sequence of layers to form outputs, the computer configured to:
establish, within the ANN, at least one iterative block, made up of one or of multiple layers, which is to be implemented multiple times;
establish a number J of iterations, for which the iterative block is at most to be implemented;
map, by the iterative block, an input of the iterative block onto an output;
feed the output to the iterative block as input and again mapping by the iterative block onto a new output; and
feed, once the iterations of the iterative block are completed, the output supplied by the iterative block input to a layer of the ANN following the iterative block, or provide the output supplied by the iterative block as output of the ANN;
wherein a portion of parameters, which characterize a behavior of the layers in the iterative block, is changed during switches between the iterations, for which the iterative block is implemented.
